(19) United States
(12) Patent Application Publication
(10) Pub. No.: US 2009/0142530 A1
(43) Pub. Date: Jun. 4, 2009

(54) Compositions and Structures Having Tailored Oxygen Transmission

(75) Inventors: Donna Lynn Visioli, Lower Gwynedd, PA (US); Kevin Patrick McAllister, Bear, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/327,138

(22) Filed: Dec. 3, 2008

Related U.S. Application Data
(60) Provisional application No. 61/005,239, filed on Dec. 3, 2007.

(51) Int. Cl. C08L 33/02; B32B 1/00

(52) U.S. Cl. 428/36.6; 525/201

(57) ABSTRACT

A composition comprises an ethylene copolymer having copolymerized units of ethylene and vinyl acetate, alkyl acrylates, alkyl methacrylates, acrylic acid and ionomers thereof, methacrylic acid and ionomers and a potassium-containing component comprising a potassium-neutralized ionomer and optionally an organic acid or salt thereof and/or a polyol. Also disclosed is an article comprising or produced from the composition, which includes films, sheets and shaped articles.

This application claims priority to U.S. provisional application Ser. No. 61/005239, filed Dec. 3, 2007; the entire disclosure of which is incorporated herein by reference.

This invention relates to gas and moisture permeable compositions and their uses. The compositions are useful in packaging, especially the packaging of fresh produce.

### BACKGROUND OF THE INVENTION

Traditionally, packaged perishable food required a high barrier to permeation by oxygen for long shelf life. Perishable food products are subject to contamination when exposed to microbial organisms such as bacteria, molds and the like. Contamination can result in accelerated spoilage, toxin formation and other harmful effects. Packaging such perishable goods in gas impermeable materials such as foil, coated paperboard and oxygen barrier films can provide a barrier to microbial contamination. However, the rapid market growth of packaged foods which respire, like fresh produce, or are subject to anaerobic spoilage, like seafood, have led to an increase in interest in materials with high permeability to oxygen and/or water vapor.

Oxygen-permeable films are desirable because they prevent growth of anaerobic organisms such as Clostridium botulinum, which produces a potent toxin that is the causative agent of botulism, from contaminating a food item while retaining moisture within the food item. The films also allow ingress of oxygen in packaging for fresh meat which improves its appearance while retaining moisture.

Packaging perishable foods also desires to control the moisture level in the food. For fresh cut produce, it is also desirable to control permeation to both water vapor and oxygen for optimum shelf life. Fresh cut fruit and vegetables and other respiring biological materials consume oxygen (O₂) and produce carbon dioxide (CO₂), at rates that depend upon temperature and the stage of their development. Their storage stability depends on the relative and absolute concentrations of O₂ and CO₂ in the atmosphere surrounding them, and on temperature. For example, CO₂ can react with condensed moisture in the package to form carbonic acid, which can affect the quality of the produce by accelerating degradation of the produce.

Accordingly, a respiring material is desirably stored in a container whose permeability to O₂, CO₂ and water vapor is correlated with (i) the atmosphere outside the package and/or (ii) the rates at which the material consumes O₂ and produces CO₂ and water to produce an atmosphere within the container having O₂, CO₂ and moisture concentrations equal to the optimum values for preservation of the material.

The packaging atmosphere depends on the stored material. For example, some materials, e.g. broccoli, are best stored in an atmosphere containing 1-2% O₂ and 5-10% CO₂. For other materials, an atmosphere containing 1-2% O₂ and 12-30% CO₂, e.g. about 15% CO₂, is preferred. CO₂ concentrations of 10 to 30% can slow the respiration rate of some fruit and reduce the activity of some decay-causing organisms; for example, a CO₂ concentration of 20% delays grey mold decay in raspberries and extends their shelf life. It may be desirable for packaging produce that needs high levels of CO₂ to have relatively high permeation to water vapor to avoid moisture buildup which could lead to carbonic acid formation.

Attempts to improve packaging of food items include controlled atmosphere packaging and modified atmosphere packaging. See, e.g., U.S. Pat. Nos. 4,734,324, 4,830,863, 4,842,875, 4,879,078, 4,910,032, 4,923,703, 5,045,331, and 5,160,768, and EP applications 0351115 and 0351116, where packages rely on various means of containing atmospheres of a composition within packages made of materials with low gas permeability. However, fresh food items consume and emit gases as they respire and the atmosphere in these package forms cannot easily adjust to the changes in composition due to respiration.

Therefore, it is desirable to develop packaging forms which permit selective exchange of gases between the inside of the package and the outside. The ideal oxygen transmission rate (OTR) and water vapor transmission rate (WVTR) for a packaging material varies depending on the respiration rate of the produce, storage temperature, and physiological state of the produce. However, for many species of produce, a film with an OTR of around 8000 cc/m²-atm-24 hours and WVTR of around 1500 g/m²-atm-24 hours provides a good balance of properties.

Commercially available resins have a wide range of gas permeability. For example, water vapor permeation values (WVPV) can vary from less than 60 g-25 μm/m²-atm-24 h for conventional olefin copolymers such as polyethylene to 40,000 g-25 μm/m²-atm-24 h for very permeable polyetheramides and polyesteramides.

Coextrusion of breathable materials with layers of conventional resins to tailor WVTR of a film can be problematic because the WVTR of a coextruded film is a weighted average of the components, coextrusion with even a very thin layer of a lower WVPV material will greatly reduce the WVTR of the coextruded structure. Blending to increase WVTR can also be problematic because polyetheramides or polyesteramides has limited compatibility with the moderate WVPV ethylene copolymers and it is difficult to produce blends with good mechanical and optical properties and good heat sealability that are required for packaging applications. See e.g., US2003/0198715, US2005/0199524, US2007/0020466, and US2007/0078223.

### SUMMARY OF THE INVENTION

A composition is provided that can be useful for preparing packaging material and packages for foods (such as fresh produce) and other such biological materials which are no longer growing, but still respiring as they deteriorate to preserve the color, quality and/or shelf-life of the foods or deteriorating biological material for extended periods of time.

The composition comprises, consists essentially of, consists of, or is produced from an ethylene-containing polymer and a potassium-containing composition wherein

the ethylene-containing polymer comprises at least one ethylene copolymer, at least one acid copolymer, at least one ionomer of the acid copolymer, or combinations of two or more thereof; the ethylene copolymer comprises copolymerized or repeat units derived from ethylene and a monomer selected from the group consisting of vinyl acetate, alkyl acrylate, alkyl methacrylate, and combinations of two or more thereof; the acid copolymer comprises copolymerized or repeat units derived from ethylene and methacrylic acid, methacrylic acid, or combinations thereof; and the ionomer is neutralized by a cation other than potassium; and

the potassium-containing composition comprises a polar copolymer and optionally a polar compound, a polyol, or combinations thereof; the polar copolymer includes an ethylene acid copolymer, an ionomer of the ethylene acid copolymer, or combinations thereof; the ethylene acid copolymer comprises copolymerized or repeat units derived from ethylene, at least one C₃₋₈ α,β-ethylenically unsaturated carboxylic acid, and optionally a comonomer; the comonomer includes alkyl acrylate, alkyl methacrylate, or combinations thereof; the alkyl group has 1 to 8 carbon atoms; the units derived from the unsaturated carboxylic acid is from about 3 to about 35 weight %, based on the weight of the ethylene acid copolymer; the polar compound is selected from the group consisting of aliphatic organic carboxylic acid, salt of the acid, or combinations thereof; the acid has fewer than 36 carbon atoms; greater than 80% of the carboxylic acid moieties of the polar copolymer, or of the polar compound, when present, or of both the ethylene acid copolymer and the polar copolymer, are neutralized by potassium cations, or by a combination of potassium and one or more alkali metal, transition metal, and alkaline earth metal cations in which potassium comprises a preponderance of the cations; and the polyol has at least three hydroxyl moieties.

An article comprises, consists essentially of, consists of, or is produced from the composition. The article includes film or shaped (or molded) article. The film includes monolithic or monolayer structure or multilayer structure where the film also includes sheet. The multilayer structure comprises, consists essentially of, consists of, or is produced at least one layer obtained from the composition. The shaped article can also comprise or be produced from the film.

A package comprises the composition and includes packages which may comprise a perishable foodstuff.

### DETAILED DESCRIPTION OF THE INVENTION

The entire disclosures of all references are incorporated herein by reference.

The term “(meth)acrylic” is a shorthand notation for compounds having either acrylic functionality, methacrylic functionality or a mixture of compounds of both types, and generally indicates that either or both types of compounds are used or can be useful. For example, “alkyl (meth)acrylate” refers to an alkyl acrylate, an alkyl methacrylate, or to a mixture thereof.

The term “produced from” is an open ended term meaning a claim does not exclude any other un-recited elements. For example, when a composition comprises or is produced from an ethylene-containing polymer and a potassium-containing ionomer, the composition can comprise the ethylene-containing polymer and the potassium-containing ionomer, if the ethylene-containing polymer and the potassium-containing ionomer do not react with each other. If the ethylene-containing polymer reacts with the potassium-containing ionomer to produce another entity, then the composition is produced from the ethylene-containing polymer, the potassium-containing ionomer, and un-recited element(s).

Melt flow rate or Melt Index (MI) is measured in accordance with ASTM D-1238 at 190° C., using a 2.16 kg mass, and is reported in units of g/10 minutes.

OTR is the rate of oxygen transmission or diffusion through the smallest dimension (thickness) of a generally planar structure such as a film. WVTR is the rate of water vapor transmission. OTR is measured at one atmosphere pressure and can be expressed in cc/m²-atm-24 hours and WVTR values are expressed in g/m²-atm-24 hours. Transmission rate is generally inversely dependent on the thickness of that structure (for a given film material, thicker structures will have lower transmission rates). OTR data can be expressed as oxygen permeation values (OPV) normalized at 25 μm thickness (cc-25 μm/m²/atm-24 hours). Similarly, WVTR can be normalized to a water vapor permeation value (WVPV) at 25 μm thickness (g-25 μm/m²/atm-24 hours). If one is interested in the shelf life of a packaged product, transmission rates through the packaging material are relevant. For comparing the efficiency in permeation for various compositions, the normalized value is most relevant. That is, if one wished to increase the transmission rate of a package without changing the thickness of the packaging material, one would use a material with a higher permeation value.

The polymer blend compositions disclosed are solid compositions and may be used to provide structures having a combination of tailored oxygen and moisture permeability properties, good formability and structural strength and can be useful for containing food products and the like that require breathable package structures. Perishable goods that can be packaged include meat, fish, poultry, sausage, cheese or fresh produce, including vegetables and/or fruits, as well as other perishable goods such as cut flowers.

Many previous permeable membranes are microporous; that is, they are permeable due to the presence of microscopic pores through which vapor can pass. The composition disclosed herein can be formed into a monolithic membrane that functions as a selectively permeable barrier. Monolithic membranes, in contrast to microporous membranes, have high water-entry pressure and are waterproof and liquidproof and can provide good barriers to liquid water while still allowing permeability to water vapor under appropriate conditions. A monolithic membrane can also function as a barrier to odors and may have better tear strength compared to microporous membranes.

The blended compositions provide a balance of tailored permeability, heat seal strength and transparency that is useful for packaging fresh foods.

The ethylene copolymer includes copolymers having copolymerized units of ethylene and a comonomer selected from the group consisting of vinyl acetate, alkyl acrylates, alkyl methacrylates, and combinations of two or more thereof wherein the polymer contains copolymerized units of at least 2 weight % of the comonomer.

The percentage of copolymerized vinyl acetate units in ethylene vinyl acetate copolymer (EVA) can vary from about 2 weight % to about 40 weight % of the total weight of the copolymer or even higher, about 2 to about 40 weight %, or 10 to 40 weight %. EVA may have an MI of from about 0.1 to about 40 or about 0.3 to about 30 g/10 minutes. EVA can be modified by methods well known in the art, including chemical reaction by grafting with an unsaturated carboxylic acid or its derivatives, such as maleic anhydride or maleic acid. A mixture of two or more different EVAs can be used.

Depending on comonomer content and molecular weight, the range of WVPV of EVA copolymers is from about 40 to about 250 g-25 μm/m²-atm-24 h.

Suitable ethylene/vinyl acetate copolymers are sold by E. I. du Pont de Nemours and Company, Wilmington, Del. (DuPont) as Elvax®.

The amount of the alkyl (meth)acrylate comonomer incorporated as copolymerized units into an ethylene/alkyl (meth)acrylate copolymer can vary from a few weight % or about 0.1 or 2 to about 45% or even higher, about 5 to about 45%, 10 to 35%, or 10 to 28%, based on the weight of the copolymer. Mixtures of ethylene/alkyl(meth)acrylate copolymers may also be used, so long as the level of copolymerized units of (meth)acrylate is within the above-described range, based on the total weight of copolymer present.

The alkyl group in the alkyl(meth)acrylate includes methyl, ethyl, n-butyl, or combinations of two or more thereof.

Ethylene copolymers can be produced by any processes known to one skilled in the art, including processes that involve use of a tubular reactor or an autoclave and may be continuous or batch processes. For example, in one such process, disclosed in U.S. Pat. No. 5,028,674, ethylene, the alkyl acrylate, and optionally a solvent such as methanol are fed continuously into a reactor such as the type disclosed in U.S. Pat. No. 2,897,183, together with an initiator. Because the processes for producing an ethylene copolymer is well known to one skilled in the art, the description of which is omitted for the interest of brevity. Ethylene (meth)alkyl acrylate copolymers produced using an autoclave process can be obtained commercially, for example from Exxon/Mobil Corp, and/or from Elf AtoChem North America, Inc. Ethylene alkyl (meth)acrylate copolymers obtained using a tubular reactor process are produced at high pressure and elevated temperature. In a tubular reactor, the inherent consequences of dissimilar reaction kinetics for the respective ethylene and alkyl acrylate comonomers are alleviated or partially compensated for by the intentional introduction of monomers along the reaction flow path within the tubular reactor. Such copolymers can be obtained commercially from DuPont as Elvaloy® AC.

The Ml of an ethylene copolymer may depend on the balance of properties sought from the blend intended to provide the desired mix of oxygen permeability and structural properties needed for a specific packaging structure.

The ethylene copolymer can be a mixture of copolymers such as ethylene alkyl (meth)acrylates having various melt indices or having different alkyl groups.

The range of WVPV of ethylene alkyl (meth)acrylate copolymers can be about 68 to about 600 g-25 μm/m²-atm-24 h.

The acid copolymers are copolymers of ethylene and a C₃-C₈ α,β-ethylenically unsaturated carboxylic acid. Acrylic and methacrylic acids are preferred comonomers. For example, an acid copolymer can also include those acid copolymers that contain an additional monomer that can disrupt the crystallinity of the copolymer.

Examples of acid copolymers can be described as E/X/Y copolymers where E is ethylene, X is the α,β-ethylenically unsaturated carboxylic acid, and Y is a third comonomer. The α,β-ethylenically unsaturated carboxylic acid is present in an amount of from 3 to 35, 4 to 25, or 5 to 20 weight % and Y can be present in amounts of from 0 to 35, 1 to 35, or 4 to 25 weight %, all based on the weight of the acid copolymer.

Suitable third comonomers (Y) can be alkyl acrylates and alkyl methacrylates, wherein the alkyl groups have from 1 to 8 or 1 to 4 carbon atoms. Additionally, the copolymers may be higher order copolymers having more than one alkyl acrylate or alkyl methacrylate comonomer of this type.

Acid copolymers having high levels of α,β-ethylenically unsaturated carboxylic acid can be prepared in continuous reactors by use of “co-solvent technology” as described in U.S. Pat. No. 5,028,674 or by employing somewhat higher pressures than those at which copolymers with lower acid levels can be prepared.

Acid copolymers include, but are not limited to ethylene (meth)acrylic acid dipolymers, ethylene(meth)acrylic acid/n-butyl (meth)acrylate terpolymers, ethylene/(meth)acrylic acid/iso-butyl (meth)acrylate terpolymers, ethylene/(meth)acrylic acid/methyl (meth)acrylate terpolymers, ethylene/(meth)acrylic acid/ethyl (meth)acrylate terpolymers, or combinations of two or more thereof.

The acid copolymers that are at least partially neutralized to the corresponding salts are ionomers. Suitable ionomers are prepared from the acid copolymers described above by methods known in the art of preparing ionomers, such as those described in U.S. Pat. No. 3,262,272. Ionomers are obtained from the ethylene acid copolymers described above by neutralization, generally accomplished by melt extrusion in the presence of a neutralizing agent, such as Mg(OH)₂, for example. The ionomers include partially neutralized ethylene acid copolymers, particularly ethylene/(meth)acrylic acid copolymers. The ionomers may be neutralized to any level that does not result in an intractable (that is, not melt processable) polymer without useful physical properties. Cations that are useful in preparing this component include lithium, sodium, zinc, calcium, or magnesium or combinations of two or more of these cations. Ionomers are commercially available from DuPont as Surlyn®.

The range of WVPV of ionomers that do not contain potassium can be from about 20 to about 70 g-25 μm/m²-atm-24 h.

The potassium-containing composition comprises potassium-neutralized ionomer compositions.

The first component of the potassium-neutralized ionomer compositions is an ethylene acid copolymer wherein the acid moieties of the copolymer are at least partially neutralized by potassium. The acid copolymers used in this component include acid copolymers as disclosed above.

Potassium compounds for neutralizing the acid copolymer can include compounds of potassium, optionally small amounts (such as less than 5 or 1 or 0.1 or 0.01%) of other cations such as other alkali metal (for example, lithium or sodium) ions, transition metal ions or alkaline earth ions and mixtures or combinations of such cations. Potassium compounds include formates, acetates, nitrates, carbonates, hydrogencarbonates, oxides, hydroxides or alkoxides of the ions of potassium and other alkali metals, and formates, acetates, nitrates, oxides, hydroxides or alkoxides of the ions of alkaline earth metals, and transition metals. Of note are potassium hydroxide, potassium acetate, potassium carbonate, or combinations of two or more thereof.

The acid moieties of the acid copolymer can be nominally neutralized by potassium cations, or a combination of potassium and one or more alkali metal, transition metal, or alkaline earth metal cations, such as lithium, sodium, magnesium, calcium, or zinc, wherein potassium comprises a preponderance of the cations. The neutralization can be at least 80%, 90%, or 100%.

A mixture of two or more different acid copolymers can be used in the ionomer composition in place of a single acid copolymer. For example, mixture of ethylene/methacrylic acid copolymers and an ethylene/methyl acrylate copolymer having an overall composition of 10 to 20 weight % of methacrylic acid and 0.5 to 5 weight % of methyl acrylate wherein the combined acid moieties present are nominally neutralized to at least 80% with potassium.

The organic acids, salts or mixtures thereof can be monobasic, dibasic, or polybasic aliphatic organic carboxylic acids or their salts, particularly those having fewer than 36 carbon atoms. The acids may be saturated or unsaturated, and may include multiple sites of unsaturation. The acids may be optionally substituted with from one to three substituents independently selected from the group consisting of C₁-C₈ alkyl, OH, and OR¹ in which each R¹ is independently C₁-C₈ alkyl, C₁-C₆ alkoxyalkyl or COR²; and each R² is independently H or C₁-C₈ alkyl. Examples of organic acids include C₄ to less than C₃₆ (such as C₃₄, C₄₋₂₆, C₆₋₂₂, or C₁₂₋₂₂) acids.

If salts of the acids are employed, the organic acid salts can be any metal salts such as potassium salts. Other salts can be utilized in combination with potassium salts so long as the oxygen permeability of the composition can be maintained at an effective level. Other salts that can be utilized include sodium or lithium salts, for example.

The organic carboxylic acids and salts may have a low volatility for purposes of melt blending or otherwise mixing with one or more of the other materials that make up the second component of the compositions of the invention, but volatility is not a limiting factor and organic acids with lower carbon content can be used. It can be preferred, however, that the organic acid or salt be non-volatile (the acids or salts do not volatilize in the range of temperatures useful for melt blending) and non-migratory (the organic acid does not bloom to the surface of the ethylene acid copolymer or composition under normal storage conditions at ambient temperatures). Temperatures for melt blending can range from 150° C. to 250° C.

The acids and/or their salts may effectively modify the ionic morphology and/or reduce the level of crystallinity of the polar copolymer (ethylene acid copolymer and/or ionomer thereof).

Examples of organic acids include but are not limited to caproic acid, caprylic acid, capric acid, palmitic acid, lauric acid, stearic acid, isostearic acid, behenic acid, erucic acid, oleic acid, and linoleic acid and their mixtures. More preferably, the naturally derived organic fatty acids such as palmitic, stearic, oleic, behenic, or combinations of two or more thereof. Saturated organic acids, such as stearic acid and behenic acid, can be used for the purpose of reducing organoleptic properties of structures made from the compositions. Such structures can include films and other packaging materials.

Saturated, branched organic acids (e.g., isostearic acid or acids substituted with at least one C₁₋₈ alkyl group) comprise CH (methenyl) moiety and CH₃ (methyl) moieties. Saturated, linear organic acids (e.g., behenic acid) comprise only one CH₃ and no CH moieties. Saturated, branched organic acids can be useful to provide greater oxygen permeability. Hydroxy-substituted organic acids includes organic acids substituted with a hydroxyl (—OH) moiety and derivatives wherein the H of the hydroxyl moiety is replaced by R¹ moieties defined above. Hydroxy-substituted organic acid can be substituted with one OH or one OR¹. Isostearic acid and 12-hydroxystearic acid are examples of organic acids substituted with one alkyl group and one OH, respectively. Combinations of any of the organic acids contemplated herein can be used.

The degree of neutralization of the potassium-containing composition can be formed in a step wherein blends of the polar copolymer and optional organic acids are neutralized together or merely mixed together. For example, the polar copolymer and organic acid may be in the form of ethylene acid copolymers, ethylene acid copolymer ionomers, carboxylic acids, carboxylic acid salts, (i.e. carboxylate salts), or combinations of two or more thereof prior to treatment with a source of neutralizing cations. An ionomer having a low level of neutralization can be further neutralized using such a treatment. Thus, compositions also include polar copolymer and organic acid where the total level of neutralized carboxylic acid moieties is less than 80%, providing that a sufficient amount of neutralizing agent, such as metal oxide, metal hydroxide or other neutralizing agent, is present to provide a nominal neutralization of greater than 80% of the total acid moieties present. For example, an ionic compound that is a source of cations, such as potassium hydroxide, may be blended with a organic acid and an ethylene acid ionomer having less than 80 weight % neutralization in an amount such that the mixture is converted to a composition wherein greater than 80% of the carboxylic acid moieties of the organic acid and the carboxylic acid groups of the ethylene acid copolymer ionomer present are neutralized to the corresponding carboxylate salts. Thus, a stoichiometric amount of cations will be present that, in aggregate, is sufficient to neutralize greater than 80% of the carboxyl groups present in the combined polar copolymer and organic acid species to form carboxylate salts thereof. Conversely, an ionomer having a high level of neutralization can be converted to one having a lower level of neutralization as a result of blending with a mixture of nonneutralized acid copolymers or acids in an appropriate melt mixing process that accomplishes ion transfer. Mixing method, shear conditions, and mixing time and are well known in the art and are disclosed for example in U.S. Pat. No. 6,777,472.

Mixture of acid copolymer and organic acid may be in a particular ratio such that the total organic acids or salts thereof or mixtures thereof, are present in an amount of from about 3 to about 55%, or about 5 to about 25%, based on the total combined weight of polar copolymer and organic acid.

A polyol having at least three hydroxyl moieties, such as glycerol, can be included in the potassium-containing composition at about 0.1%, about 1%, or about 1.5%, up to about 10%, about 5, or about 3%.

A common polyol is glycerol, due to its low viscosity and ease of incorporation into polymeric compositions. See e.g., JP H10-193495A, JP H11-077928, JP H08-134295, JP H10-060185, and JP H10-060186. Because of its volatility, glycerol can cause smoking during processing and/or formation of deposits.

A polyol other than glycerol can have low volatility, such as diglycerol, hexanetriol, pentaerythritol, polyglycerol, sorbitol, or combinations of two or more thereof. Such polyols may have at least 4 hydroxyl moieties. A diglycerol can be mixed with as little as 10% water to produce a mixture of low enough viscosity to easily incorporate into the ionomer.

Diglycerol (or diglycerin) is the common name for the condensed dimer of glycerol. Condensation processes can lead to diglycerol with relatively high levels of impurities, including glycerol.

Diglycerol is also made via the reaction of epichlorohydrin with glycerol and epoxide ring-opening, which can provide products of higher purity. Diglycerol prepared in this manner is commercially available from Solvay as a mixture of predominately α,α′-diglycerol [4-oxa-1,2,6,7-hepatanetriol], for example more than 80%, α,β-diglycerol [HOCH₂CHOHCH₂OCH(CH₂OH)₂], for example about 10-15%, and β,β′-diglycerol [(HOCH₂)₂CHOCH(CH₂OH)₂] for example, less than 1%.

A diglycerol that has a low amount of glycerol, unlike traditional materials that generally contain at least 10% glycerol, can also be used such as, for example, a diglycerol composition having low glycerol content (less than 7, 5, or 3 weight % glycerol), which is commercially available from Solvay.

Example of potassium-containing composition includes a potassium ionomer, composed of a mixture of ethylene/methacrylic acid copolymers and an ethylene/methyl acrylate copolymer having an overall composition of 14.9% methacrylic acid and 0.9% methyl acrylate, wherein the combined acid moieties present are nominally neutralized to 84.8% with potassium to which is added 8 weight % of diglycerol.

The potassium-containing composition can be prepared by blending a potassium ionomer, optional organic acid or potassium salt, and/or optional polyol, such as diglycerol, so that they are homogeneously dispersed to the naked eye. The potassium ionomer can be produced by neutralizing a corresponding ethylene acid copolymer, as disclosed above.

Other materials (e.g. additives or other polymers as described below) may be also mixed with dispersed in the potassium ionomer-ethylene containing polymer-optional polyol matrix. The blend may be obtained by combining the component materials using any melt-mixing method known in the art. For example, the component materials may be mixed using a melt-mixer such as a single or twin-screw extruder, blender, kneader, Banbury mixer, roll mixer, etc., to give the gas permeable composition. Alternatively a portion of the component materials can be mixed in a melt-mixer, and the rest of the component materials subsequently added and further melt-mixed. The potassium ionomer and the polyol, when used, may be combined, subsequently dry blended with the ethylene-containing polymer and processed directly into a finished article through, for example, extrusion molding, coextrusion molding, extrusion lamination, extrusion coating, cast film extrusion, blown film extrusion or the like.

Of note is a process comprising adding the polyol as a solution in water to a potassium ionomer in an extruder or other mixing equipment; and removing the water (for example, by evaporation such as from a vacuum port on an extruder) to produce a potassium ionomer-polyol mixture; processing the potassium ionomer-polyol mixture into pellets; and optionally dry blending the pellets of the potassium ionomer-polyol mixture with pellets of ethylene-containing polymer to form a potassium ionomer-polyol mixture and processing the mixture into a finished product.

When the components of the composition are within the ranges described above, mechanical properties such as stiffness can be balanced with the oxygen permeability necessary for effective packaging of various types of produce for freshness. For example, packaging film and containers require different levels of stiffness. Depending on its natural form and structure certain food may be more effectively packaged in rigid or flexible containers or films to insure it is protected against damage during transportation and storage, but the proper degree of oxygen permeability is maintained. Similarly, packaging with different optical properties can be desirable for aesthetic reasons.

The compositions have tailored oxygen permeability and can be used to prepare monolithic or multilayer structures. The compositions can be converted to blown films, for example but not limitation, by feeding a combination of pellets of ethylene-containing polymer and pellets of potassium-containing composition, into a blown film machine, melt blending them and extruding them through an annular die according to procedures well known in the art of preparing blown films. Cast films can be prepared by melt blending the ethylene-containing polymer and the potassium-containing composition blend and extruding through a slit die according to procedures well known in the art of preparing cast films.

The compositions may be used to form multilayer structures. Ethylene-containing polymers or ionomers disclosed also can be employed as additional layers in such multilayer structures, in addition to tailored oxygen permeability as disclosed herein.

The oxygen permeability of a multilayer structure is related to the thickness and permeability of each of the layers in the following manner:

$$\frac{1}{{OPV}_{package}} = \frac{{x}_{1}}{{OPV}_{1}} + \frac{{x}_{2}}{{OPV}_{2}} + … \qquad ( 1 )$$

where OPV_{package} is the permeability of the package normalized to 1 mil, OPV₁ is the permeability of layer 1, OPV₂ the permeability of layer 1, x1 is the fraction of the structure thickness that comprises layer 1, and x2 is the fraction of the structure thickness that comprises layer 2.

By using formula (1) combinations of highly permeable and less permeable materials for various layers can be identified that may achieve the desired permeability requirements of the application, while maintaining desired strength and forming properties.

Other embodiments can be envisioned such as a multilayer structure having at least one layer consisting essentially of the composition (hereinafter a “permeable blend composition”) with at least one other layer comprising another material.

A specific embodiment of the invention provides an oxygen permeable multilayer polymeric structure comprising:
(i) at least one polymeric layer consisting essentially of the permeable blend composition; and
(ii) at least one additional polymeric layer comprising a copolymer of ethylene and vinyl acetate.

This embodiment may comprise three polymeric layers wherein both outer layers comprise the ethylene/vinyl acetate copolymer of (ii) and an interior layer consists essentially of the permeable blend composition of (i).

Another specific embodiment of the invention provides an oxygen permeable multilayer polymeric structure comprising:
(i) at least one polymeric layer consisting essentially of the permeable blend composition; and
(ii) at least one additional polymeric layer comprising a copolymer of ethylene and an alkyl (meth)acrylate.

Another specific embodiment provides an oxygen permeable multilayer polymeric structure comprising
(i) at least one polymeric layer consisting essentially of the permeable blend composition; and
(ii) at least one additional polymeric layer comprising a metallocene polyethylene (mPE) having a density of less than 0.91 g/cc; or a blend of a mPE having a density of less than 0.91 g/cc and a low density polyethylene.

Preferably this embodiment comprises three polymeric layers wherein both outer layers comprise the mPE or mPE blend of (ii) and a middle layer consists essentially of the permeable blend composition of (i).

Still another embodiment provides an oxygen permeable multilayer polymeric structure comprising:
(i) at least one polymeric layer consisting essentially of the permeable blend composition; and
(ii) at least one polymeric layer comprising an ethylene acid copolymer having copolymerized units of ethylene, at least one C₃ to C₈ α,β-ethylenically unsaturated carboxylic acid, and optionally a comonomer selected from the group consisting of alkyl acrylates and alkyl methacrylates, wherein the alkyl groups have from 1 to 8 carbon atoms, or ionomers of said copolymers, and wherein the weight percentage of copolymerized units of said unsaturated carboxylic acid in said ethylene acid copolymer is from about 3 to about 35 weight %, based on the weight of said ethylene acid copolymer, and wherein from 0% to 90% of the acid groups are neutralized.

Preferably this embodiment is formed of three polymeric layers wherein both outer layers comprise the composition of (ii) and a middle layer consists essentially of the permeable blend composition of (i).

Additional specific embodiments include films or other structures with at least three different layers, one of which consists essentially of the permeable blend composition.

Accordingly, a specific embodiment of the invention provides an oxygen permeable multilayer polymeric structure comprising:
(i) at least one polymeric layer consisting essentially of the permeable blend composition; and
(ii) at least one polymeric layer comprising an ethylene acid copolymer having copolymerized units of ethylene, at least one C₃ to C₈ α,β-ethylenically unsaturated carboxylic acid, and optionally a comonomer selected from the group consisting of alkyl acrylates and alkyl methacrylates, wherein the alkyl groups have from 1 to 8 carbon atoms, or ionomers of said copolymers, wherein the weight percentage of copolymerized units of said unsaturated carboxylic acid in said ethylene acid copolymer is from about 3 to about 35 weight %, based on the weight of said ethylene acid copolymer; and wherein from 0% to about 90% of the acid is neutralized; and
(iii) at least one additional polymeric layer comprising a mPE (metallocene-produced polyethylene) having a density of less than 0.91 g/cc; or a blend of a mPE having a density of less than 0.91 g/cc and a low density polyethylene.

Another specific embodiment of the invention provides an oxygen permeable multilayer polymeric structure comprising:
(i) at least one polymeric layer consisting essentially of the permeable blend composition; and
(ii) at least one polymeric layer comprising an ethylene acid copolymer having copolymerized units of ethylene, at least one C₃ to C₈ α,β-ethylenically unsaturated carboxylic acid, and optionally a comonomer selected from the group consisting of alkyl acrylates and alkyl methacrylates, wherein the alkyl groups have from 1 to 8 carbon atoms, or ionomers of said copolymers, wherein the weight percentage of copolymerized units of said unsaturated carboxylic acid in said ethylene acid copolymer is from about 3 to about 35 weight %, based on the weight of said ethylene acid copolymer, and wherein from 0% to about 90% of the acid is neutralized; and
(iii) at least one additional polymeric layer comprising a copolymer of ethylene and vinyl acetate or a copolymer of ethylene and an alkyl (meth)acrylate.

In some multilayer structures, it may be desirable that the permeable blend composition comprises an ethylene-containing polymer that is the same as that used in the at least one additional layer.

Depending on the thickness and compositions of the individual layers of the multilayer film, such films will have OPVs greater than 8,000 cc-mil/m²-day. Other embodiments will have OPV greater than 10,000 cc-mil/m²-day.

The packages may comprise films wrapped around the packaged product and optionally comprising other packaging materials. Packages may also be formed of one or more portions of film bonded together, for example by heat sealing. Such packages may be in the form of pouches, packets, vacuum skin packaging and the like. Pouches are formed from film web stock by cutting and heat sealing separate pieces of web stock and/or by a combination of folding and heat sealing with cutting. Tubular films may be formed into pouches by sealing across the lengthwise direction of the tube (transverse seal). Other packages include containers with lidding films prepared from permeable compositions as described herein and flexible packages made by laminating or heat sealing the permeable composition to another web stock to improve characteristics such as stiffness and appearance.

Preferred packages comprise one or more of the preferred or notable films or structures as described herein. Preferred packaged products comprise one or more of the preferred or notable films or structures as described herein.

A package can also be surrounded by air comprising a container comprising one or more control sections which provide the only way in which oxygen, carbon dioxide and water vapor can enter or leave the container comprising the composition above; and within the container, a biological material which is actively respiring and which is selected from the group consisting of foods and flowers.

Although the oxygen permeable compositions described herein are described primarily in the form of films, the compositions can also be provided in other forms, including sheets thicker than typical films, shaped articles, and molded articles. These forms impart the desired oxygen permeability properties to a package just as described for the films.

A film or sheet comprising the oxygen permeable compositions could be further processed by thermoforming into a shaped article. For example, a film or sheet comprising an oxygen permeable composition could be formed into a shaped piece that could be included in packaging. Thermoformed articles have a shape in which a sheet of material forms a concave surface such as a tray, cup, can, bucket, tub, box or bowl. The thermoformed article may also comprise a film with a cup-like depression formed therein. Thermoformed film or sheet may be shaped to match the shape of the material to be packaged therein. Flexible films when thermoformed as described retain some flexibility in the resulting shaped article. Thicker thermoformed sheets may provide semi-rigid or rigid articles. Thermoformed articles may be combined with additional elements, such as a generally planar film that serves as a lid sealed to the thermoformed article. It may be desirable that the lidding film also be prepared from an oxygen permeable composition as described herein.

Profiles are defined by having a particular shape and by their process of manufacture known as profile extrusion. Profiles are not film or sheeting, and thus the process for making profiles does not include the use of calendering or chill rolls or the use of injection molding processes. Profiles are fabricated by melt extrusion processes that begin by extruding a thermoplastic melt through an orifice of a die forming an extrudate capable of maintaining a desired shape. The extrudate is drawn into its final dimensions while maintaining the desired shape and then quenched in air or a water bath to set the shape, thereby producing a profile. In the formation of simple profiles, the extrudate preferably maintains shape without any structural assistance. With extremely complex shapes, support means are often used to assist in shape retention. A common shape of a profile is tubing.

Other techniques forming articles known to one skilled in the art may be used.

The following examples are to further illustrate the invention and are not meant to be unduly limiting the scope of the invention.

### EXAMPLES

### Materials Used

KI-1: A potassium ionomer, composed of a mixture of ethylene methacrylic acid (EMAA) copolymers and an ethylene methyl acrylate (EMA) copolymer having an overall composition of 14.9% methacrylic acid and 0.9% methyl acrylate. The combined acid moieties present are nominally neutralized to 84.8% with potassium and the MI is 1.95.

KI-DG: KI-1 to which was added 8% by weight of diglycerol. The diglycerol was a grade that had very low glycerol content, which reduces smoking in the final product during processing.

Ionomer-3: An E/10% MAA/9.3% iBA (isobutylacrylate) terpolymer neutralized with 3.16 weight % zinc oxide, with MI of 1 g/10 min.

EMA-1: An E/30% MA dipolymer with MI of 3 g/10 min.

EVA-1: An E/30% VA dipolymer with MI of 3 g/10 min.

Blown film samples were prepared by feeding pellet blends of KI-1 or KI-DG with EMA-1, EVA-1 or Ionomer-3 into a blown film line. The line is composed of a 1.5″ Davis extruder with 24:1 L/D having a general purpose screw with 3/1 compression ratio, coupled to a Killion blown film die with a 2.5″ diameter. The mixing ratios are summarized in Table 1.

TABLE 1

| | Composition | | | | |
|---|---|---|---|---|---|
| Example | KI-1 | KI-DG | Ionomer-3 | EMA-1 | EVA-1 |
| 1 | 30 | 0 | 0 | 0 | 70 |
| 2 | 60 | 0 | 0 | 0 | 40 |
| 3 | 90 | 0 | 0 | 0 | 10 |
| 4 | 30 | 0 | 0 | 70 | 0 |
| 5 | 60 | 0 | 0 | 40 | 0 |
| 6 | 90 | 0 | 0 | 10 | 0 |
| 7 | 0 | 30 | 0 | 0 | 70 |
| 8 | 0 | 90 | 0 | 0 | 10 |
| 9 | 0 | 30 | 0 | 70 | 0 |
| 10 | 0 | 90 | 0 | 10 | 0 |
| 11 | 0 | 30 | 70 | 0 | 0 |
| 12 | 0 | 90 | 10 | 0 | 0 |
| C13 | 100 | 0 | 0 | 0 | 0 |
| C14 | 0 | 100 | 0 | 0 | 0 |
| C15 | 0 | 0 | 100 | 0 | 0 |
| C16 | 0 | 0 | 0 | 100 | 0 |
| C17 | 0 | 0 | 0 | 0 | 100 |

The Examples were converted into monolayer films of approximately 25 μm in thickness through the blown film process. The films were measured for their OTR and MVTR and the transmission rates were normalized to permeation values. The transmission rates and permeation values are shown in Table 2 as the average of two film samples for each composition. Permeation properties for the Comparative Examples were obtained from previous similar tests. For samples with high water permeability (above 500 g/m²-atm-24 h), the water vapor transmission tests were conducted on a Mocon Permatran-W 101 K, following ASTM D6701 -01, at 37.8° C. For the other samples (permeability is below 500 g/m²-atm-24 h), the transmission tests were conducted on a Mocon Permatran-W 700, following ASTM F1249-01. For the OTR measurement the test was conducted on a Mocon OX-Tran 2/21 at 23° C. and 50% relative humidity.

TABLE 2

| | | WVPV | OTR | OPV |
|---|---|---|---|---|
| | WVTR | (g-25 μm/m²- | (cc/m²- | (cc-25 μm/m²- |
| | (g/m²-atm-24 h) | atm-24 h) | atm-24 h) | atm-24 h) |
| 1 | 630 | 640 | 13900 | 12200 |
| 2 | 620 | 690 | 7800 | 7800 |
| 3 | 1140 | 990 | 4100 | 4220 |
| 4 | 610 | 770 | 11450 | 11700 |
| 5 | 600 | 730 | 7580 | 8300 |
| 6 | 970 | 1130 | 4670 | 5080 |
| 7 | 450 | 580 | 6770 | 7700 |
| 8 | 1040 | 1480 | 1860 | 2560 |
| 9 | 410 | 580 | 6780 | 8710 |
| 10 | 960 | 1290 | 1880 | 2550 |
| 11 | 70 | 110 | 6560 | 9380 |
| 12 | 1410 | 2120 | 3100 | 5080 |
| C13 | — | 4300 | — | 3340 |
| C14 | — | 13000 | — | 1960 |
| C15 | — | 32 | — | 6600 |
| C16 | — | 600 | — | 15400 |
| C17 | — | 210 | — | 18600 |

Specimens for heat seal strength were prepared at 0.3 MPa seal bar pressure and 0.5 second dwell time using a sample film attached to adhesive-backed tape. The seal area was 25 mm wide.

TABLE 3

| | Heat Seal Temperature (° F.) | | |
|---|---|---|---|
| | 230 | 240 | 250 |
| Example | Heat Seal Strength (g/25 mm) | | |
| 1 | 1366 | 1093 | 1137 |
| 2 | 1221 | 1151 | 1126 |
| 3 | 432 | 406 | 368 |
| 4 | 1192 | 944 | 968 |
| 5 | 1286 | 967 | 979 |
| 6 | 342 | 328 | 309 |
| 7 | 2135 | 1682 | 1567 |
| 8 | 7 | 470 | 688 |
| 9 | 1263 | 1127 | 1033 |
| 10 | 5 | 373 | 432 |
| 11 | 2383 | 2293 | 2478 |
| 12 | 859 | 833 | 899 |

Haze was measured using ASTM D1003 and reported in Table 4.

TABLE 4

| Example | % |
|---|---|
| 1 | 96 |
| 2 | 95 |
| 3 | 62 |
| 4 | 94 |
| 5 | 94 |
| 6 | 69 |
| 7 | 62 |
| 8 | 4 |
| 9 | 57 |
| 10 | 5 |
| 11 | 5 |
| 12 | 30 |

1. A composition comprising or produced from an ethylene-containing polymer and a potassium-containing composition wherein
the ethylene-containing polymer comprises at least one ethylene copolymer, at least one acid copolymer, at least one ionomer of the acid copolymer, or combinations of two or more thereof; the ethylene copolymer comprises copolymerized or repeat units derived from ethylene and a monomer selected from the group consisting of vinyl acetate, alkyl acrylate, alkyl methacrylate, and combinations of two or more thereof; the acid copolymer comprises copolymerized or repeat units derived from ethylene and methacrylic acid, methacrylic acid, or combinations thereof; and the ionomer is neutralized by a cation other than potassium; and
the potassium-containing composition comprises a polar copolymer and optionally a polar compound, a polyol, or combinations thereof; the polar copolymer includes an ethylene acid copolymer, an ionomer of the ethylene acid copolymer, or combinations thereof; the ethylene acid copolymer comprises copolymerized or repeat units derived from ethylene, at least one C₃₋₈ α,β-ethylenically unsaturated carboxylic acid, and optionally a comonomer; the comonomer includes alkyl acrylate, alkyl methacrylate, or combinations thereof; the alkyl group has 1 to 8 carbon atoms; the units derived from the unsaturated carboxylic acid is from about 3 to about 35 weight %, based on the weight of the ethylene acid copolymer; the polar compound is selected from the group consisting of aliphatic organic carboxylic acid, salt of the acid, or combinations thereof; the acid has fewer than 36 carbon atoms; greater than 80% of the carboxylic acid moieties of the polar copolymer, or of the polar compound, when present, or of both the ethylene acid copolymer and the polar copolymer, are neutralized by potassium cations, or by a combination of potassium and one or more alkali metal, transition metal, and alkaline earth metal cations in which potassium comprises a preponderance of the cations; and the polyol has at least three hydroxyl moieties.

2. The composition of claim 1 consisting essentially of the ethylene-containing polymer and the ethylene acid copolymer wherein greater than 80% of the total combined carboxylic acid moieties of the ethylene acid copolymer component are neutralized by potassium cations, or a combination of potassium and one or more alkali metal, transition metal, or alkaline earth metal cations, wherein potassium comprises a preponderance of the cations.

3. The composition of claim 2 wherein the ethylene-containing polymer is an ethylene vinyl acetate copolymer.

4. The composition of claim 2 wherein the ethylene-containing polymer is an ethylene alkyl acrylate copolymer.

5. The composition of claim 4 wherein the ethylene-containing polymer is an ethylene methyl acrylate copolymer.

6. The composition of claim 1 consisting essentially of the ethylene-containing polymer, the ethylene acid copolymer, and the polyol wherein greater than 80% of the total combined carboxylic acid moieties of the ethylene acid copolymer component are neutralized by potassium cations, or a combination of potassium and one or more alkali metal, transition metal, or alkaline earth metal cations in which potassium comprises a preponderance of the cations.

7. The composition of claim 6 wherein the ethylene-containing polymer is an ethylene vinyl acetate copolymer.

8. The composition of claim 6 wherein the ethylene-containing polymer is an ethylene alkyl acrylate copolymer.

9. The composition of claim 8 wherein the ethylene-containing polymer is an ethylene methyl acrylate copolymer.

10. The composition of claim 6 wherein the ethylene-containing polymer is an ethylene acrylic acid ionomer or ethylene methacrylic acid ionomer; wherein the ionomer is neutralized by a cation other than potassium.

11. An article comprising or produced from a composition wherein the article includes film or sheet, a shaped or molded article, or combinations thereof; the film or sheet includes monolayer structure or multilayer structure; and the composition is as recited in claim 1.

12. The article of claim 11 including a monolithic or monolayer structure.

13. The article of claim 11 including a multilayer structure and at least one layer of the structure comprises or is produced from composition.

14. A package comprising or produced from a monolayer film or sheet, or a multilayer film or sheet or a composition wherein the monolayer film or sheet is as recited in claim 12, the multilayer film or sheet is as recited in claim 13 and the composition is as recited in claim 1.

15. The package of claim 14 further comprising a perishable foodstuff.

16. The package of claim 14 comprising a container comprising one or more control sections wherein the container is surrounded by air; oxygen, carbon dioxide, or water vapor enters or exits the package exclusively through the section; and the container comprises actively respiring biological material.

17. The package of claim 16 wherein the biological material is food or flower.

18. The package of claim 17 wherein the food is produce.
